(19) United States
(12) Patent Application Publication
(10) Pub. No.: US 2025/0090934 A1
(43) Pub. Date: Mar. 20, 2025

(54) DISPLAY OF USER INTERFACES BASED ON A CONTEXT OF AN ELECTRONIC DEVICE

(71) Applicant: Apple Inc., Cupertino, CA (US)

(72) Inventors: Ioana NEGOITA, Mountain View, CA (US); Ian PERRY, San Jose, CA (US); Trent A. GREENE, Santa Clara, CA (US); Brian W. TEMPLE, Santa Clara, CA (US); David LOEWENTHAL, Seattle, WA (US); Thomas J. MOORE, Northglenn, CO (US); Thomas G. SALTER, San Francisco, CA (US)

(21) Appl. No.: 18/823,550

(22) Filed: Sep. 3, 2024

Related U.S. Application Data
(60) Provisional application No. 63/583,567, filed on Sep. 18, 2023.

(51) Int. Cl. A63B 71/06; A63B 24/00

(52) U.S. Cl. CPC A63B 71/0622; A63B 24/0006; A63B 24/0062; A63B 2024/0065; A63B 2071/0636; A63B 2071/0638; A63B 2220/806

(57) ABSTRACT

Some examples of the disclosure are directed to systems and methods for displaying one or more user interfaces based on a context of an electronic device within a physical environment. In some examples, the electronic device detects initiation of an exercise activity associated with a user of the electronic device, optionally while a computer-generated environment is presented at the electronic device. In some examples, in response to detecting the initiation of the exercise activity, the electronic device activates an exercise tracking mode of operation. In some examples, while the exercise tracking mode of operation is active, the electronic device captures one or more images of a physical environment. In some examples, in accordance with detecting, in the one or more images, a feature of the physical environment, the electronic device performs a first operation associated with the exercise tracking mode of operation.

### CROSS-REFERENCE TO RELATED APPLICATIONS

This application claims the benefit of U.S. Provisional Application No. 63/583,567, filed Sep. 18, 2023, the content of which is herein incorporated by reference in its entirety for all purposes.

### FIELD OF THE DISCLOSURE

This relates generally to systems and methods of selectively controlling display of a user an electronic device based on a context of the electronic device within a computer-generated environment.

### BACKGROUND OF THE DISCLOSURE

Some electronic devices are used to track an activity, such as an exercise activity, of a user. In some examples, while the user is participating in the activity, the electronic device presents a user interface corresponding to the activity. There is a need for systems and methods for selectively controlling and/or updating display of the user interface corresponding to the activity based on changes in context of the electronic device in the physical environment.

### SUMMARY OF THE DISCLOSURE

Some examples of the disclosure are directed to systems and methods for displaying one or more user interfaces based on a context of an electronic device within a physical environment. In some examples, a method is performed at an electronic device in communication with a display, one or more input devices, and one or more cameras. In some examples, the electronic device detects, via the one or more input devices, initiation of an exercise activity associated with a user of the electronic device, optionally while a computer-generated environment is presented at the electronic device. In some examples, in response to detecting the initiation of the exercise activity, the electronic device activates an exercise tracking mode of operation. In some examples, while the exercise tracking mode of operation is active, the electronic device captures, via the one or more cameras, one or more images of a physical environment. In some examples, in accordance with detecting, in the one or more images, a feature of the physical environment, the electronic device performs a first operation associated with the exercise tracking mode of operation and directed toward a computer-generated environment presented at the electronic device.

In some examples, activating the exercise tracking mode of operation includes displaying, via the display, one or more representations of one or more fitness metrics associated with the exercise activity and that are tracked by the electronic device during the exercise activity. In some examples, the physical environment of which the one or more images are captured is a physical environment in which the exercise activity is performed by the user. In some examples, detecting the feature of the physical environment includes detecting a physical object that is associated with a portion of the user. In some such examples, performing the first operation includes displaying one or more visual indications of information associated with the physical object in the computer-generated environment. In some examples, detecting the feature of the physical environment includes detecting a physical object in the physical environment that corresponds to a pause of the exercise activity. In some such examples, performing the first operation includes temporarily ceasing updating display of the one or more representations of the one or more fitness metrics associated with the exercise activity (e.g., for a duration of the pause of the exercise activity).

In some examples, the one or more fitness metrics associated with the exercise activity include an intensity metric that measures and/or qualifies an intensity of the exercise activity, such as a relative difficulty of the exercise activity for the user. In some examples, detecting the feature of the physical environment includes detecting terrain or other surface material and/or a change in elevation or grade of the physical environment that corresponds to a change in the intensity metric because the feature of the physical environment will cause the relative difficulty of the exercise activity to change. In some such examples, performing the first operation includes updating the intensity metric and thus updating display of a representation of the intensity metric in the computer-generated environment.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a device according to some examples of the disclosure.

FIGS. 3A-3O illustrate examples of an electronic device updating display of a computer-generated environment based on changes in context of the electronic device within a physical environment according to some examples of the disclosure.

FIG. 4 is a flow diagram illustrating an example process for updating display of a computer-generated environment based on changes in context of an electronic device within a physical environment according to some examples of the disclosure.

### DETAILED DESCRIPTION

Some examples of the disclosure are directed to systems and methods for displaying one or more user interfaces based on a context of an electronic device within a physical environment. In some examples, a method is performed at an electronic device in communication with a display, one or more input devices, and one or more cameras. In some examples, the electronic device detects, via the one or more input devices, initiation of an exercise activity associated with a user of the electronic device, optionally while a computer-generated environment is presented at the electronic device. In some examples, in response to detecting the initiation of the exercise activity, the electronic device activates an exercise tracking mode of operation. In some examples, while the exercise tracking mode of operation is active, the electronic device captures, via the one or more cameras, one or more images of a physical environment. In some examples, in accordance with detecting, in the one or more images, a feature of the physical environment, the electronic device performs a first operation associated with the exercise tracking mode of operation and directed toward a computer-generated environment presented at the electronic device.

In some examples, activating the exercise tracking mode of operation includes displaying, via the display, one or more representations of one or more fitness metrics associated with the exercise activity and that are tracked by the electronic device during the exercise activity. In some examples, the physical environment of which the one or more images are captured is a physical environment in which the exercise activity is performed by the user. In some examples, detecting the feature of the physical environment includes detecting a physical object that is associated with a portion of the user. In some such examples, performing the first operation includes displaying one or more visual indications of information associated with the physical object in the computer-generated environment. In some examples, detecting the feature of the physical environment includes detecting a physical object in the physical environment that corresponds to a pause of the exercise activity. In some such examples, performing the first operation includes temporarily ceasing updating display of the one or more representations of the one or more fitness metrics associated with the exercise activity (e.g., for a duration of the pause of the exercise activity).

In some examples, the one or more fitness metrics associated with the exercise activity include an intensity metric that measures and/or qualifies an intensity of the exercise activity, such as a relative difficulty of the exercise activity for the user. In some examples, detecting the feature of the physical environment includes detecting terrain or other surface material and/or a change in elevation or grade of the physical environment that corresponds to a change in the intensity metric because the feature of the physical environment will cause the relative difficulty of the exercise activity to change. In some such examples, performing the first operation includes updating the intensity metric and thus updating display of a representation of the intensity metric in the computer-generated environment.

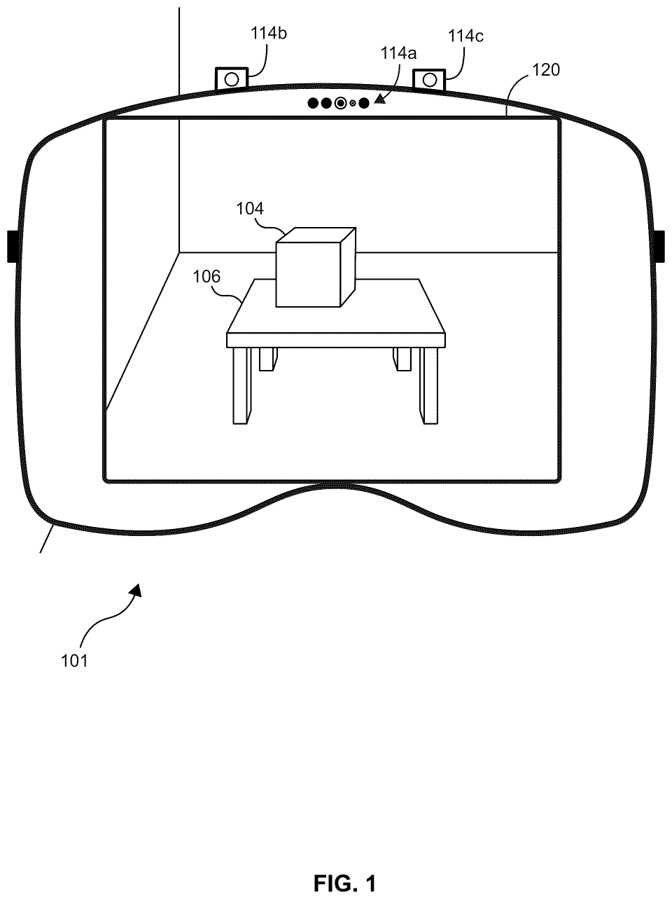

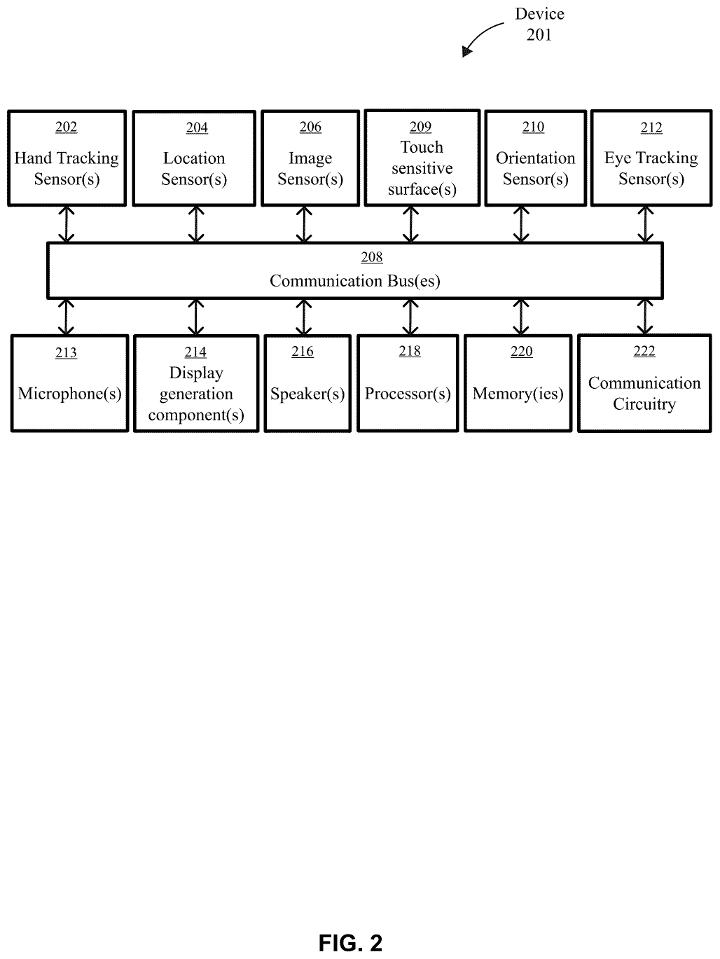

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101) using display 120.

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of electronic device 101 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment in which the electronic device 101 is located. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for a device 201 according to some examples of the disclosure. In some examples, device 201 includes one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216, one or more processors 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global position system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2, but can include fewer, other, or additional components in multiple configurations. In some examples, electronic device 201 can be implemented between two electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201, is optionally referred to herein as a user or users of the device.

Attention is now directed towards examples of selective control and/or display of one or more user interfaces associated with a detected user activity within a computer-generated environment at an electronic device based on changes in context of the electronic device within a physical environment.

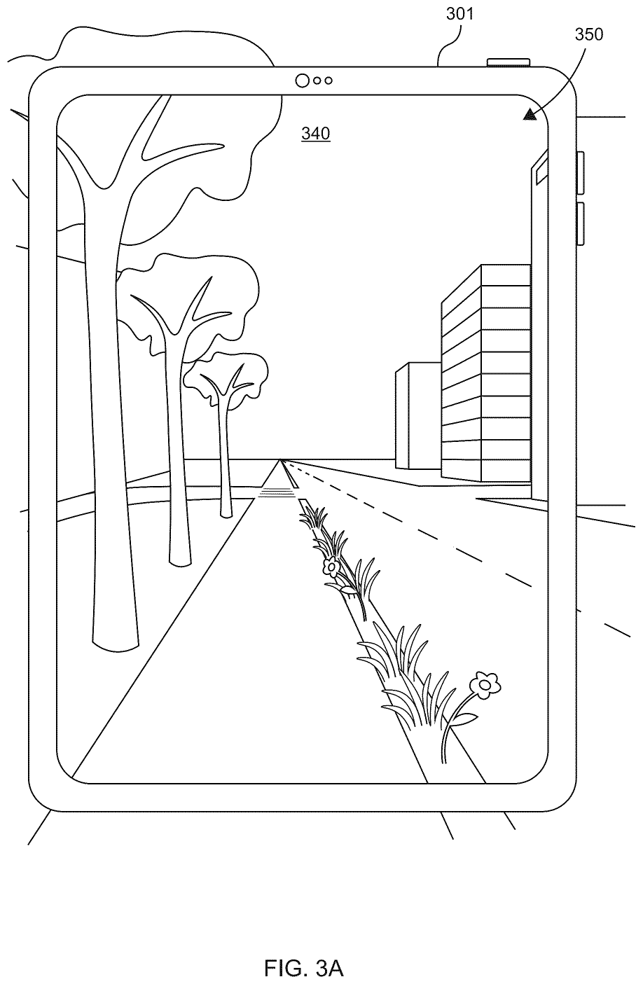

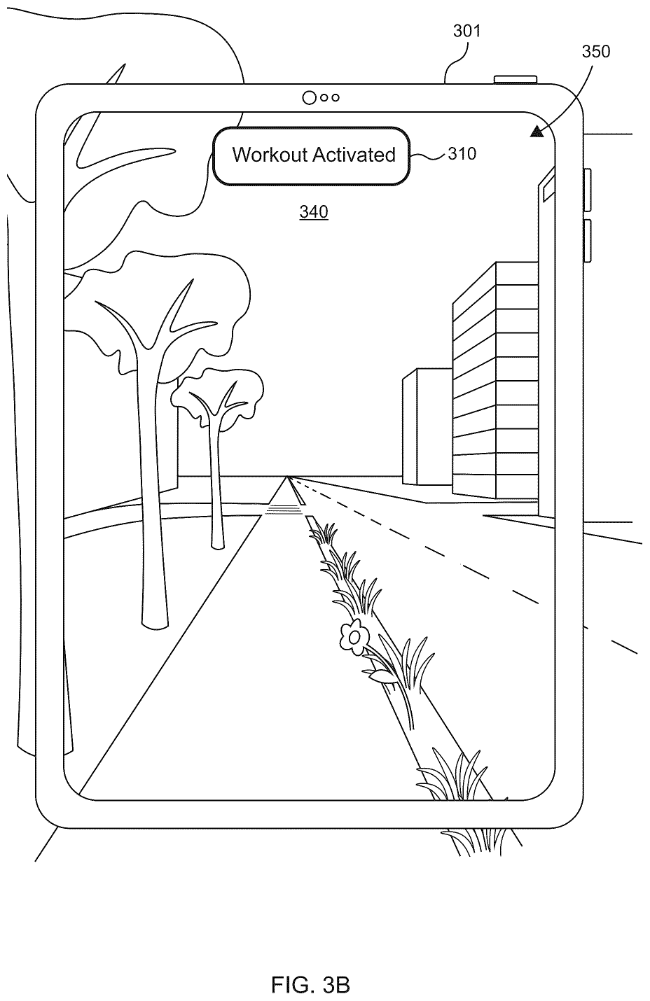

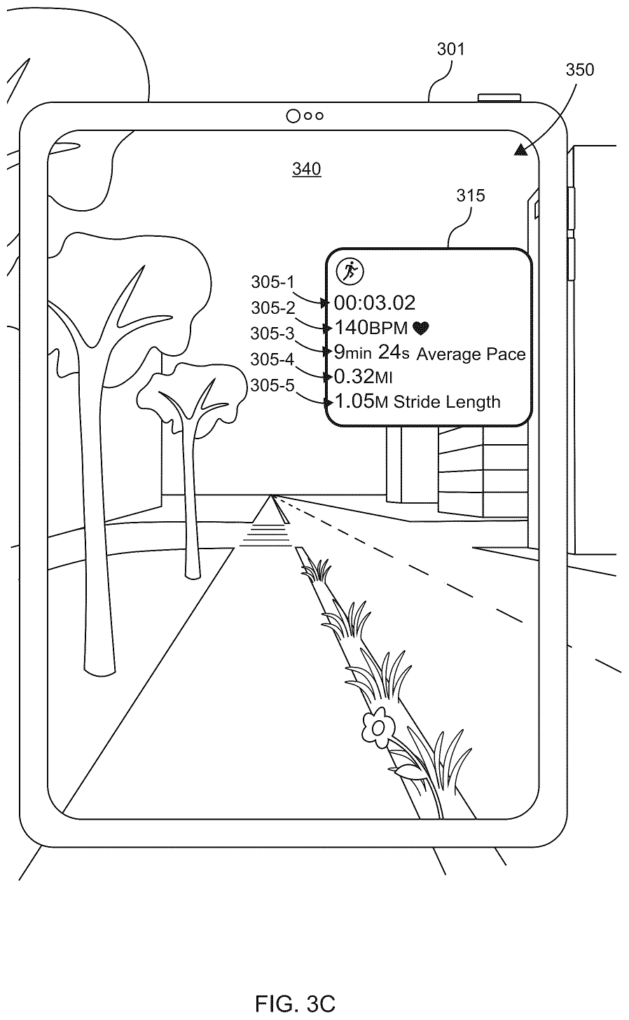

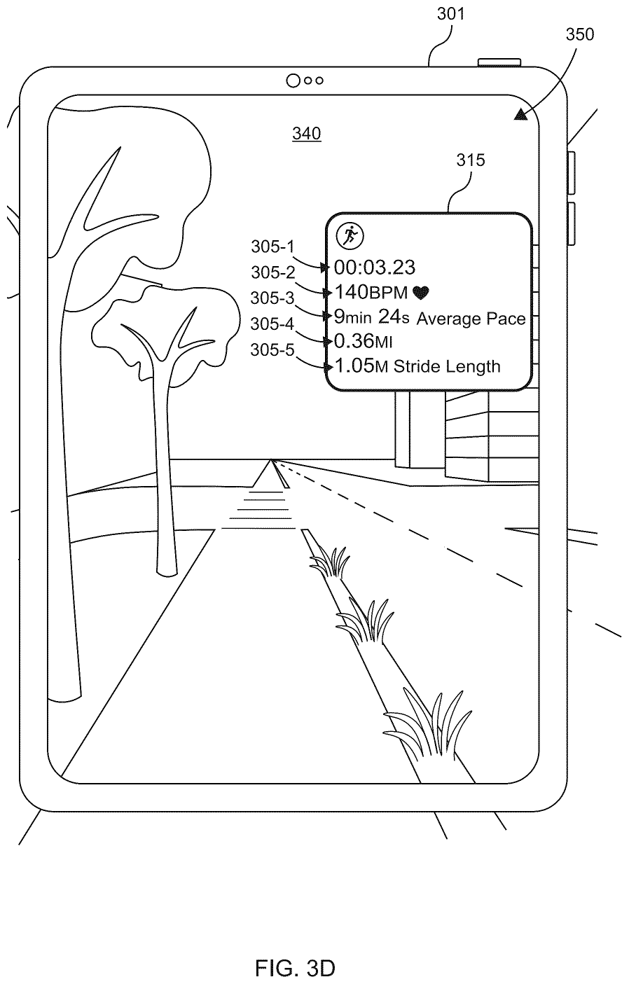

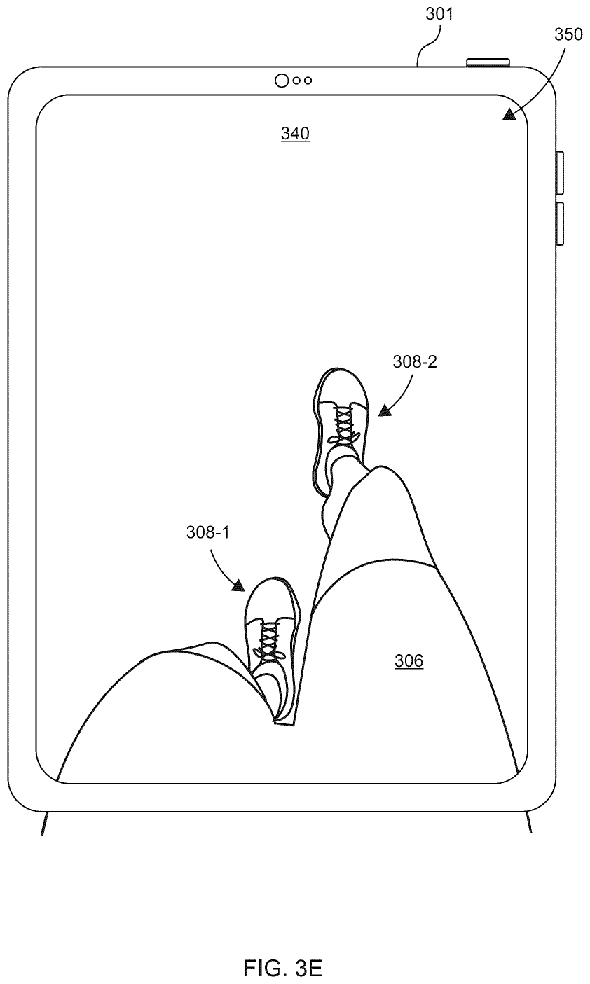

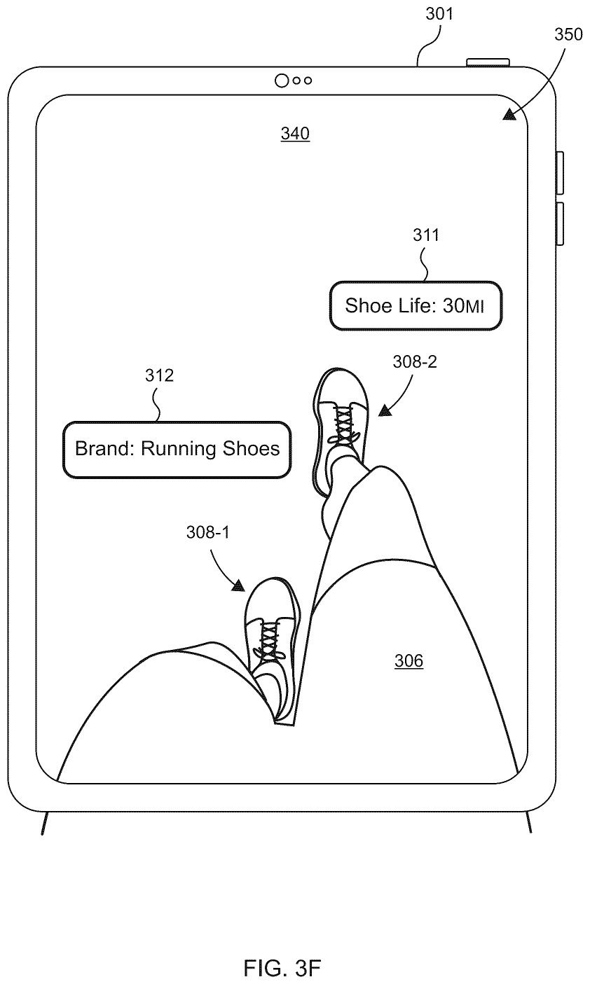

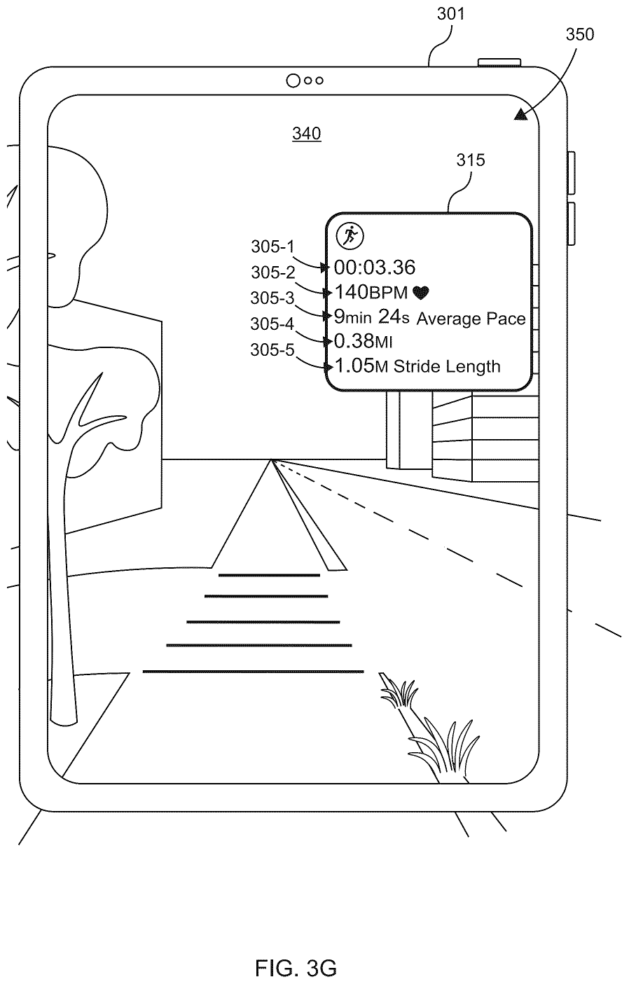

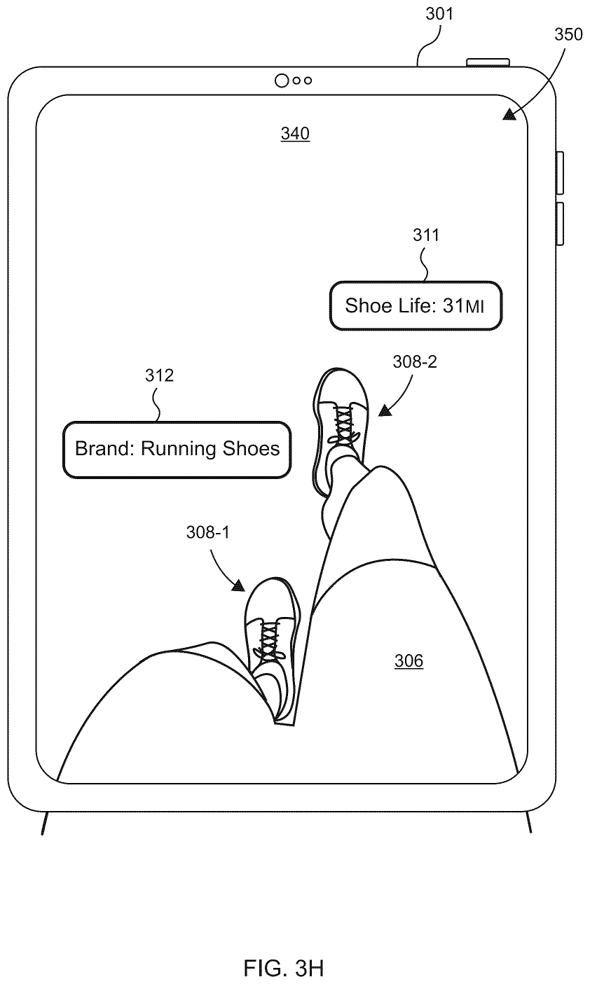

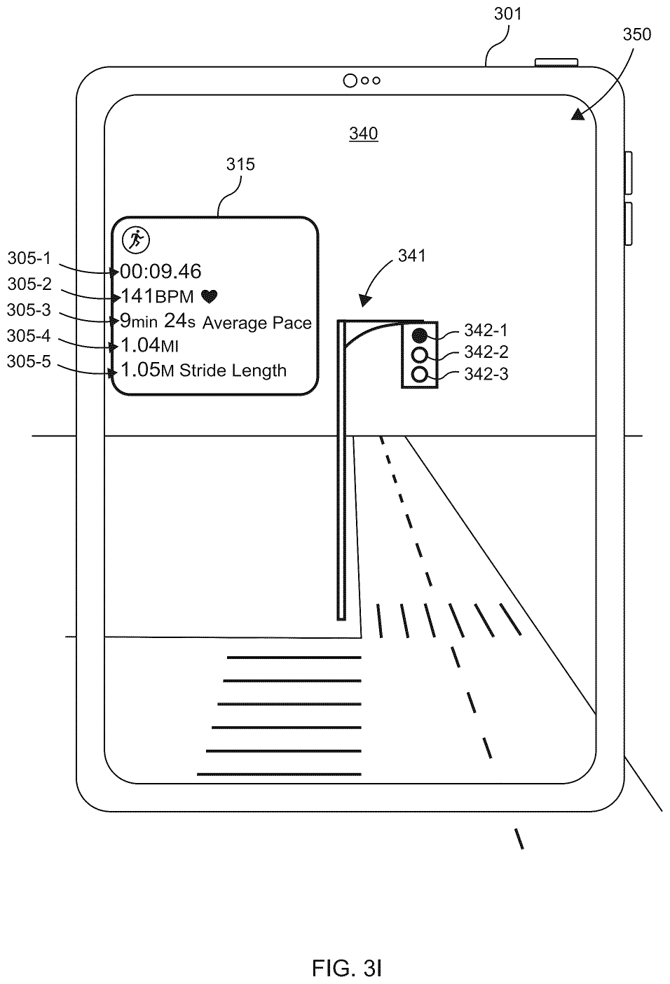

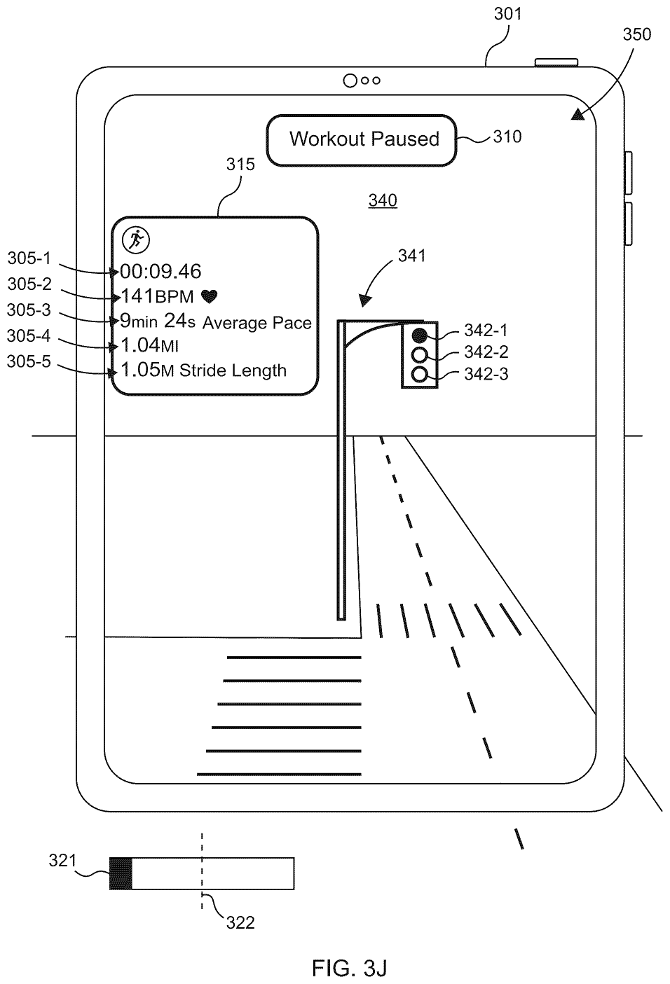

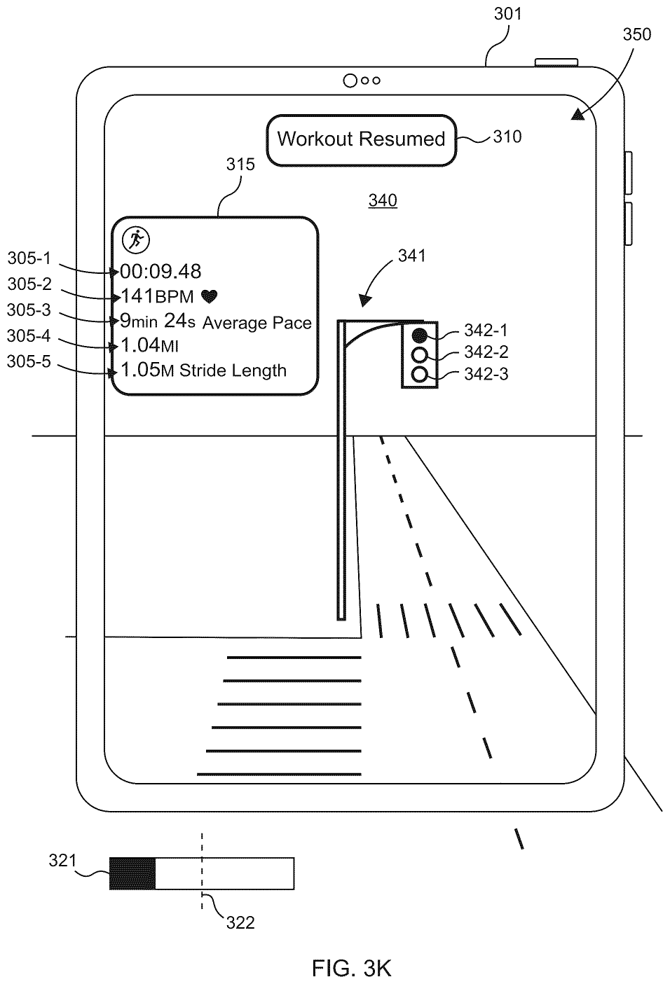

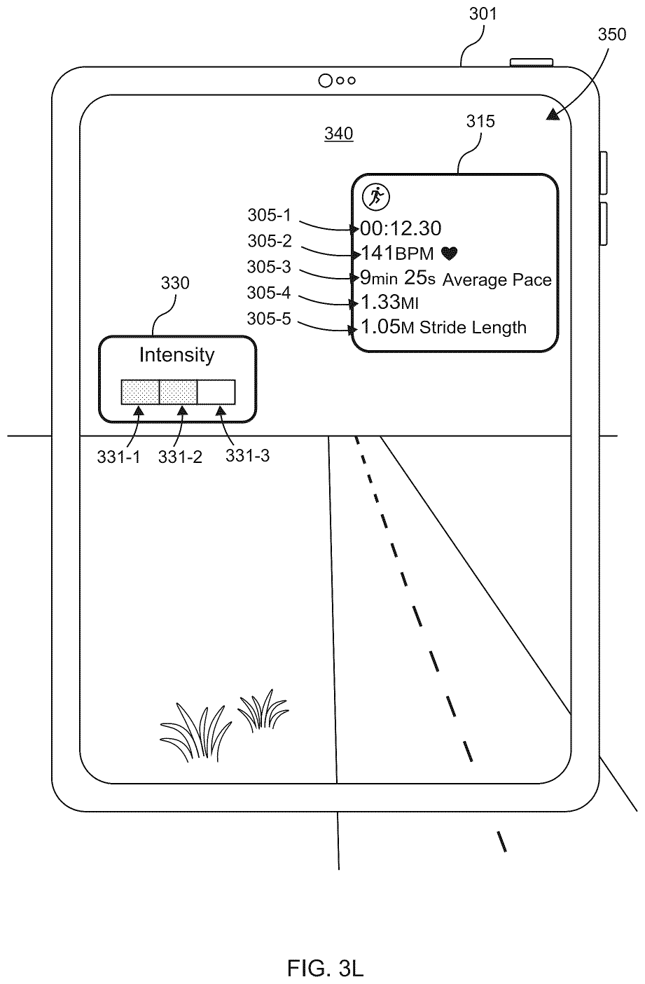

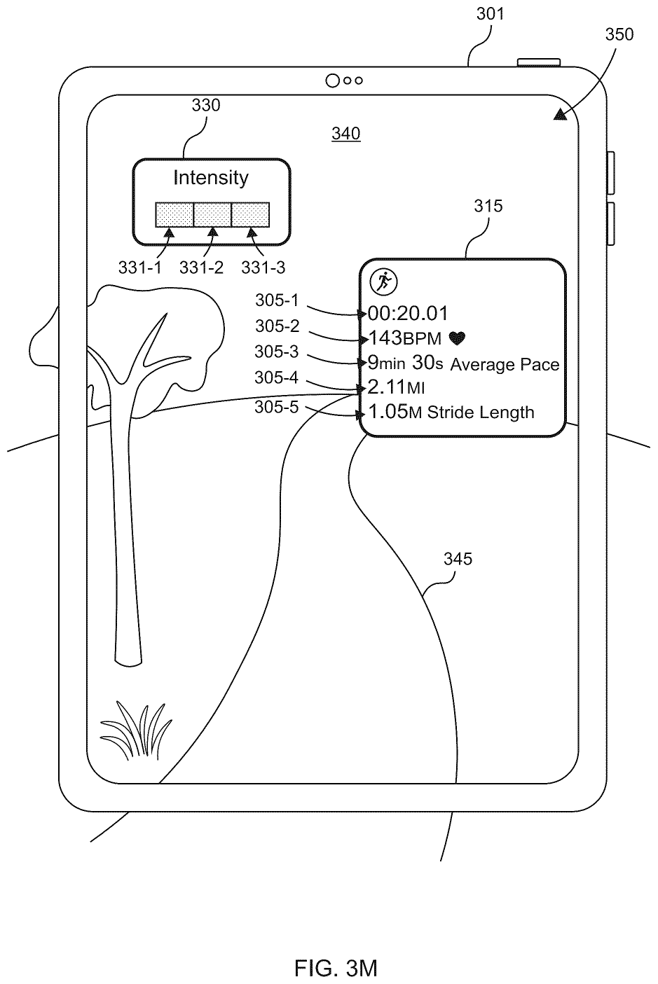

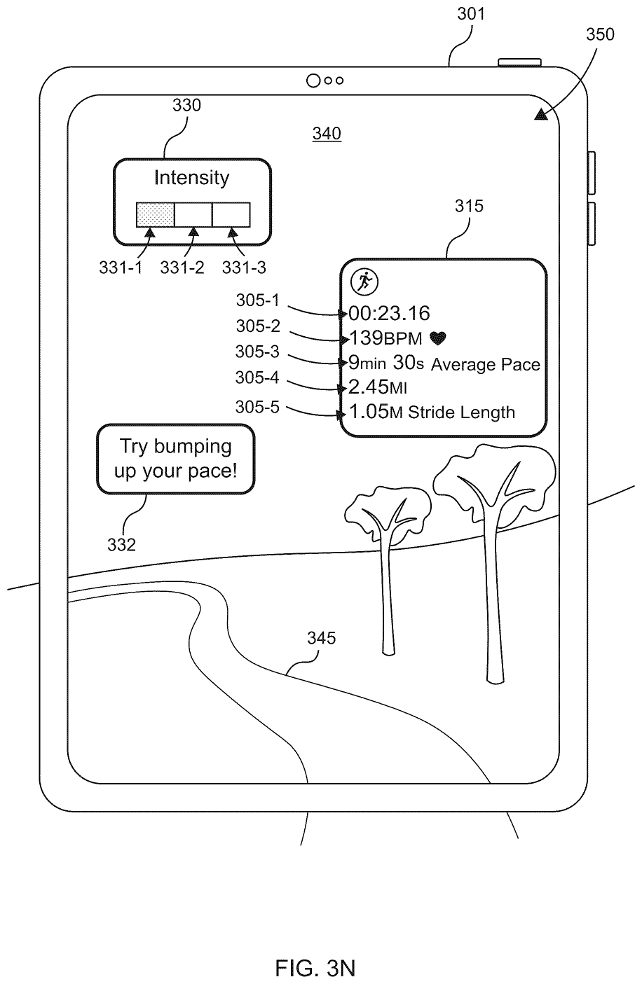

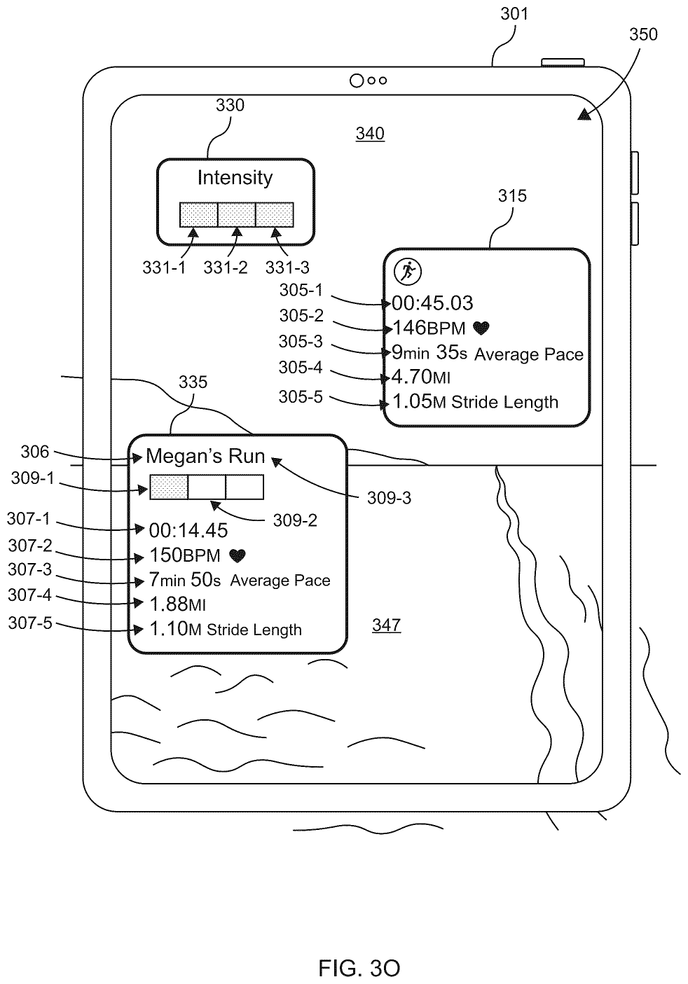

FIGS. 3A-3O illustrate examples of an electronic device updating display of a computer-generated environment based on changes in context of the electronic device within a physical environment according to some examples of the disclosure. The electronic device 301 may be similar to device 101 or 201 discussed above, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, or displays formed as lenses designed to be placed on a person's eyes (e.g., similar to contact lenses). In the example of FIGS. 3A-3O, a user is optionally wearing the electronic device 301, such that three-dimensional environment 350 (e.g., a computer-generated environment) can be defined by X, Y and Z axes as viewed from a perspective of the electronic device (e.g., a viewpoint associated with the user of the electronic device 301). Accordingly, as used herein, the electronic device 301 is configured to be movable with six degrees of freedom based on the movement of the user (e.g., the head of the user), such that the electronic device 301 may be moved in the roll direction, the pitch direction, and/or the yaw direction.

As shown in FIG. 3A, the electronic device 301 may be positioned in a physical environment (e.g., an outdoors environment) that includes a plurality of real-world objects. For example, in FIG. 3A, the electronic device 301 may be positioned in a city environment or a physical environment 340 that includes a plurality of buildings, sidewalks, roads, greenery (e.g., flowers, grass, shrubbery, trees, plants, etc.), streetlamps, streetlights, and the like (e.g., the user of the electronic device 301 is standing or walking on a sidewalk in the physical city environment). Accordingly, in some examples, the three-dimensional environment 350 presented using the electronic device 301 optionally includes captured portions of the physical environment (e.g., the city environment 340) surrounding the electronic device 301, such as one or more representations of one or more buildings in the field of view of the three-dimensional environment 350. Additionally, as shown in FIG. 3A, the three-dimensional environment 350 may include representations of the sidewalks, roads, greenery, streetlamps, and/or streetlights of the city environment 340 in which the electronic device 301 is located. In some examples, the representations can include portions of the physical environment viewed through a transparent or translucent display of electronic device 301.

In FIG. 3B, the electronic device 301 detects initiation of an exercise activity associated with the user of the electronic device 301. For example, from FIGS. 3A to 3B, the electronic device 301 detects, via one or more sensors (e.g., such as the sensor(s) described with reference to FIG. 2), movement of the electronic device 301 within the physical environment 340 caused by movement of the user of the electronic device 301. In some examples, the exercise activity corresponds to a walking activity, a running activity, a cycling activity, a lunging activity, among other possibilities, which produces movement of the electronic device 301 in the city environment 340. In some examples, detecting initiation of the exercise activity includes detecting user input via an exercise application operating on the electronic device 301. For example, the electronic device 301 detects user input for recording the exercise activity at the electronic device 301 (e.g., selection of a workout “start” option). In some examples, detecting initiation of the exercise activity includes detecting user input at a second electronic device, different from the electronic device 301. For example, the user provides user input directed to a mobile electronic device, such as a smartphone or smart watch, associated with the user and in communication with the electronic device 301, such that the electronic device 301 determines that the exercise activity has been initiated.

In some examples, as shown in FIG. 3B, in response to detecting the initiation of the exercise activity, the electronic device 301 activates an exercise tracking mode of operation. In some examples, while the exercise tracking mode of operation is active, the electronic device 301 tracks (e.g., records) one or more fitness metrics associated with the exercise activity, as discussed in more detail below. In some examples, as shown in FIG. 3B, when the electronic device 301 activates the exercise tracking mode of operation, the electronic device 301 displays a visual indication 310 that the exercise tracking mode of operation has been activated (e.g., “Workout Activated”) in the three-dimensional environment 350.

In some examples, as shown in FIG. 3C, while the exercise tracking mode of operation is active, the electronic device 301 displays a first user interface 315 associated with the exercise activity. In some examples, as shown in FIG. 3C, the first user interface 315 includes one or more representations of one or more fitness metrics associated with the exercise activity. For example, in FIG. 3C, the detected exercise activity is a running activity. Accordingly, as shown in FIG. 3C, the first user interface 315 includes a representation of a duration of the exercise activity (e.g., 3 minutes and 2 second) (305-1), a representation of a current determined heart rate of the user during the exercise activity (e.g., 140 beats per minute (BPM)) (305-2), a representation of an average running pace of the user during the exercise activity (e.g., 9 minutes and 24 seconds per mile) (305-3), a representation of a distance associated with the exercise activity (e.g., 0.32 miles) (305-4), and a representation of a stride length of the user during the exercise activity (e.g., 1.05 meters) (305-5). In some examples, the electronic device 301 determines the one or more fitness metrics associated with the exercise activity based on detected vital signs of the user (e.g., heart rate) and/or the detected movement of the user. In some examples, the vital signs and/or the movement of the user are detected via one or more sensors integrated with the electronic device 301 and/or one or more sensors integrated with a second electronic device, such as a mobile electronic device, which is worn on a portion of the user (e.g., wrist or arm) and is in communication with the electronic device 301.

In some examples, the electronic device 301 updates the one or more fitness metrics associated with the exercise activity in accordance with a progression of the exercise activity. For example, in FIG. 3D, in accordance with a progression of the running activity discussed above, the electronic device 301 updates the representations of the fitness metrics (305-1 through 305-5) in the first user interface 315 in the three-dimensional environment 350. As shown in FIG. 3D, the electronic device 301 optionally updates the representation 305-1 of the duration of the exercise activity in accordance with the progression of the exercise activity (e.g., increases the duration by 21 seconds in FIG. 3D) and/or updates the representation 305-2 of the current heart rate of the user in accordance with the progression of the exercise activity (e.g., increases the determined BPM by 1 in FIG. 3D). In some examples, the representations of the fitness metrics are updated in the first user interface 315 in real time.

In some examples, the electronic device 301 updates display of the three-dimensional environment 350 based on detected changes in a context of the electronic device 301. As used herein, the context of the electronic device 301 may include a location of the electronic device 301 within the physical environment (e.g., the city environment 340), an orientation of the electronic device 301 within the physical environment, and/or a relationship between the electronic device 301 and features of (e.g., one or more real-world objects in, a terrain of, and/or a surface elevation of) the physical environment. In some examples, detecting a feature of the physical environment includes visually detecting one or more real-world objects in the field of view of the three-dimensional environment 350 and/or changes in appearance of the one or more real-world objects in the field of view of the three-dimensional environment 350, as discussed below. As discussed herein, the electronic device 301 optionally visually detects a feature of the physical environment based on images captured by one or more cameras of the electronic device 301 (e.g., captured while the exercise tracking mode of operation is active and/or while the exercise tracking mode of operation is not active).

In FIG. 3E, the electronic device 301 visually detects one or more real-world objects associated with respective portions of the user 306 of the electronic device 301. For example, as shown in FIG. 3E, the user 306 is looking downward toward the ground of the city environment 340, which causes the orientation of the electronic device 301 to change within the city environment 340 (and thus the context of the electronic device 301 to change in the city environment 340). As shown in FIG. 3E, when the orientation of the electronic device 301 changes, the shoes 308 of the user 306 are optionally visible in the three-dimensional environment 350. For example, the electronic device 301 visually detects, via one or more cameras of the electronic device 301, a first shoe 308-1 worn on the left foot of the user 306 and a second shoe 308-2 worn on the right foot of the user 306.

In some examples, when the electronic device 301 visually detects the first shoe 308-1 and/or the second shoe 308-2 of the user 306, the electronic device 301 initiates a process to track (e.g., record) a life of the first shoe and/or the second shoe (which are optionally the same). For example, visually detecting the first shoe 308-1 and/or the second shoe 308-2 includes recognizing, via one or more processors of the electronic device 301 (e.g., using computer vision, optical recognition, and/or other techniques), the first shoe 308-1 and the second shoe 308-2 as being associated with (e.g., belonging to and/or having previously been worn by) the user 306. In some examples, the electronic device 301 automatically tracks the shoe life of a given pair of shoes associated with the user each time the user 306 is wearing the pair of shoes and the shoes are visible in the field of view of the electronic device 301 (e.g., enabling the electronic device 301 to visually detect the pair of shoes as similarly discussed above). In some examples, tracking the shoe life of the first shoe 308-1 and/or the second shoe 308-2 includes tracking/recording a distance travelled (e.g., walked, ran, etc.) in the first shoe 308-1 and/or the second shoe 308-2 (e.g., by attributing the distance 305-4 at the end of the activity to the detected shoe 308). In some examples, the electronic device 301 tracks the shoe life of the first shoe 308-1 and/or the second shoe 308-2 in the manner discussed above irrespective of whether the exercise tracking mode of operation is active and/or irrespective of whether the user 306 is participating in an exercise activity.

In some examples, as shown in FIG. 3F, when the electronic device 301 visually detects the first shoe 308-1 and/or the second shoe 308-2 in the three-dimensional environment 350, the electronic device 301 displays one or more visual indications associated with the shoe tracking of the first shoe 308-1 and/or the second shoe 308-2. For example, as shown in FIG. 3F, the electronic device 301 displays a first user interface element 311 indicating a recorded shoe life of the first shoe 308-1 and the second shoe 308-2 (e.g., “30 miles”) in the three-dimensional environment 350. Additionally, in some examples, the electronic device 301 displays a second user interface element 312 indicating a brand of the shoes (e.g., “Brand”) and/or a shoe type associated with the shoes (e.g., “Running Shoes”).

In some examples, in accordance with a determination that the first shoe 308-1 and/or the second shoe 308-2 is a new pair of shoes (e.g., a newly purchased pair of shoes (e.g., purchased via a web-browsing application or an online marketplace application on the electronic device 301), a pair of shoes worn by the user for the first time (e.g., visually detected by the electronic device 301 for the first time), etc.), the electronic device 301 initiates a new shoe life tracking for the first shoe 308-1 and/or the second shoe 308-2. In some examples, the electronic device 301 provides a prompt to the user 306 inquiring whether to enable shoe life tracking according to the processes discussed above (e.g., the electronic device 301 displays a notification or other user interface element in the three-dimensional environment 350 that includes a selectable option for enabling shoe life tracking of the new pair of shoes and a selectable option for rejecting shoe life tracking of the new pair of shoes. In some examples, the electronic device 301 automatically enables shoe life tracking of the new pair of shoes (e.g., and displays a visual confirmation that the shoe life of the new pair of shoes is being tracked).

In some examples, as alluded to above, the electronic device 301 updates the shoe life of the first shoe 308-1 and/or the second shoe 308-2 in accordance with a determination that a progression of the exercise activity causes the shoe life of the first shoe 308-1 and/or the second shoe 308-2 to change. For example, in FIG. 3G, the electronic device 301 detects a progression of the running activity, which causes the electronic device 301 to update one or more of the representations of the fitness metrics in the first user interface 315 in the three-dimensional environment 350 as previously discussed above. In some examples, the progression of the exercise activity detected in FIG. 3G causes the shoe life of the first shoe 308-1 and/or the second shoe 308-2 to increase. For example, in FIG. 3H, the electronic device 301 visually detects the first shoe 308-1 and/or the second shoe 308-2 in the three-dimensional environment 350 as similarly discussed above after detecting the progression of the running activity in FIG. 3G. In some examples, when the electronic device 301 displays the first user interface element 311 in response to visually detecting the first shoe 308-1 and/or the second shoe 308-2, the electronic device 301 updates the shoe life in the first user interface element 311 in accordance with the progression of the exercise activity (e.g., increases the shoe life by 1 mile to be 31 miles in accordance with the progression of the user 306 running another mile in the city environment 340). It should be understood that, in some examples, the above manner of tracking a shoe life of a pair of shoes may be similarly applied to other equipment and/or athletic wear associated with other exercise activities, such as weightlifting gloves, cleats (e.g., baseball, track and field, and/or football cleats), tennis racquets, golf clubs, snow/ski pants, etc., to allow the user track the usage of such equipment and/or athletic wear, which aids the user in making informed decisions regarding replacing and/or updating the equipment and/or athletic wear.

In some examples, detecting a change in the context of the electronic device 301 includes detecting a change in a visual appearance of one or more real-world objects in the city environment 340 that is visible in the three-dimensional environment 350. As shown in FIG. 3I, while the user of the electronic device 301 is running in the city environment 340, the user approaches a traffic light 341 including a red light 342-1, a yellow light 342-2, and a green light 342-3 in the city environment 340. In some examples, when the user of the electronic device 301 approaches the traffic light 341 in the city environment 340, the electronic device 301 visually detects that the red light 342-1 of the traffic light 341 is illuminated in the city environment 340, signifying that the user of the electronic device 301 is not permitted to cross the crosswalk and thus that the user of the electronic device 301 will have to stop at the crosswalk. For example, the electronic device 301 determines, via one or more processors, that the illumination of the red light 342-1 will correspond to an interruption/pause of the running activity (e.g., based on optical recognition and/or machine learning, etc.). In some examples, the electronic device 301 alternatively visually detects a stop sign, a crosswalk, a pedestrian signal, oncoming traffic (e.g., one or more vehicles), or other change in the visual appearance of the city environment 340 that correspond to an interruption/pause of the exercise activity.

In some examples, in response to visually detecting the illumination of the red light 342-1 of the traffic light 341 in the city environment 340, the electronic device 301 pauses the exercise tracking mode of operation, such that the electronic device 301 forgoes updating the one or more fitness metrics associated with the exercise activity. For example, as shown in FIG. 3J, the electronic device 301 displays the visual indication 310 in the three-dimensional environment 350 indicating that the exercise tracking mode of operation has been paused (e.g., “Workout Paused”) and forgoes updating the representation 305-1 of the duration of the exercise activity, the representation 305-3 of the running pace of the exercise activity, the representation 305-4 of the distance associated with the exercise activity, and/or the representation 305-5 of the stride length of the user during the exercise activity.

Additionally, in some examples, the electronic device 301 detects a pause in the movement of the electronic device 301. For example, in FIG. 3J, because the user ceases moving at the crosswalk in the city environment 340, the electronic device 301 is no longer moving (e.g., and/or is moving below a movement threshold (e.g., 0, 0.1, 0.5, 0.75, 1, 1.5, etc. m/s)) in the city environment 340. In some examples, the electronic device 301 pauses the exercise tracking mode of operation for a threshold amount of time 322 (e.g., 30 seconds, 1, 2, 3, 5, 10, etc. minutes) before initiating conclusion of the exercise tracking mode of operation. For example, if the electronic device 301 detects that the threshold amount of time 322 has elapsed since detecting the end of the movement of the electronic device 301, the electronic device 301 automatically deactivates the exercise tracking mode of operation or displays a visual indication in the three-dimensional environment 350 prompting the user to confirm that the exercise activity has ended. In some examples, deactivating the exercise tracking mode of operation includes ceasing display of the first user interface 315 in the three-dimensional environment 350. As shown in FIG. 3J, time bar 321 is below the threshold amount of time 322 so the electronic device 301 continues to pause the exercise tracking mode of operation.

In FIG. 3K, the electronic device 301 visually detects a change in the visual appearance of the traffic light 341 that indicates the user of the electronic device 301 is going to resume the exercise activity. For example, as shown in FIG. 3K, the electronic device 301 visually detects that the red light 342-1 is no longer illuminated and the green light 342-3 is now illuminated, indicating that the user is permitted to cross the crosswalk and continue the running activity. Accordingly, in some examples, as shown in FIG. 3K, the electronic device 301 resumes the exercise tracking mode of operation. For example, as shown in FIG. 3K, the electronic device 301 updates and/or displays the visual indication 310 indicating that the exercise tracking mode of operation is resumed (e.g., “Workout Resumed”) and resumes tracking/recording the one or more fitness metrics associated with the running activity, as indicated by the updating of one or more of the representations 305-1 through 305-5 in the first user interface 315 as similarly described above. Additionally, in some examples, the electronic device 301 resumes the exercise tracking mode of operation in FIG. 3K in response to visually detecting the illumination of the green light 342-3 in the city environment 340 in accordance with a determination that the threshold amount of time 322 discussed above has not elapsed since the exercise tracking mode of operation was first paused, as indicated by the time bar 321. Therefore, as one advantage, automatically pausing exercise tracking based on changes in context of an electronic device in a physical environment while the user is exercising enables fitness metrics associated with the exercise activity to be more accurately tracked, thereby enhancing user-device interaction and enabling the user to more accurately track and/or meet exercise goals using the electronic device.

In some examples, responding to the change in context discussed above (e.g., the change in the visual appearance of the traffic light 341) may similarly be applied to other changes in context that cause the user to be unable to progress. For example, the electronic device 301 pauses the tracking of the exercise activity as similarly discussed above in response to visually detecting a physical object or obstruction in the user's field of view that causes the motion of the user to cease, such as one or more persons, vehicles, road work, animals, etc. In the other hand, should the user intentionally cease motion, which causes the movement of the electronic device 301 to cease as well, the electronic device 301 optionally does not pause the tracking of the exercise activity in the manner discussed above. For example, if the user stops running due to exhaustion or fatigue or to interact with the electronic device 301 (or another electronic device, such as a smartphone or smartwatch), the electronic device 301 continues to track the running activity and update the fitness metrics associated with the running activity because such user action does not correspond to a change in the context of the electronic device 301 that causes the user to be unable to progress the running activity.

In some examples, tracking one or more fitness metrics associated with the exercise activity includes tracking an intensity metric associated with the exercise activity. For example, as shown in FIG. 3L, the electronic device 301 displays a second user interface 330 corresponding to the intensity metric in the three-dimensional environment 350. In some examples, the intensity metric measures and/or qualifies an intensity of the exercise activity, such as a relative difficulty of the exercise activity. In some examples, the relative difficulty of the exercise activity is based on environmental factors. For example, the electronic device 301 determines the intensity of the running activity in FIG. 3L based on a terrain of the city environment 340 in which the user is running, such as an evenness or consistency of the running path (e.g., concrete of the sidewalk versus sand on a beach) and/or a slope of the running path, a weather of the city environment 340 in which the user is running, an elevation of the city environment 340, and/or other environmental factors that contribute to the difficulty of the running activity. In some examples, the relative difficulty of the exercise activity is based on a fitness and/or health profile of the user. For example, the electronic device 301 determines the intensity of the running activity in FIG. 3L based on a determination of how “fit” and/or “in shape” the user of the electronic device 301 is, such as based on a height and/or weight of the user, an activity log of the user (e.g., how frequently the user exercises), the one or more fitness metrics discussed above (e.g., the user's average pace and/or running distance), known health conditions of the user, and/or other aspects of the user's fitness and/or health profile that contribute to the difficulty of the running activity. In some examples, the determination of the intensity metric is based on calories burned during the exercise activity and/or the average heart rate of the user during the exercise activity.

In some examples, as shown in FIG. 3L, the electronic device 301 presents the intensity metric in terms of levels or zones. For example, in FIG. 3L, the second user interface 330 includes a representation 331-1 of a first intensity level, a representation 331-2 of a second intensity level (e.g., greater than the first intensity level), and a representation 331-3 of a third intensity level (e.g., greater than the first intensity level and the second intensity level). As shown in FIG. 3L, the electronic device 301 is visually emphasizing (e.g., highlighting, bolding, and/or changing a color of) the representation 331-1 of the first intensity level and the representation 331-2 of the second intensity level, which indicates that the user is currently performing the running activity at the second intensity level. It should be understood that, in some examples, the intensity metric discussed above may be expressed in additional and/or alternative ways in the three-dimensional environment 350 (e.g., within the second user interface 330). For example, the electronic device 301 may quantify the intensity metric in terms of calories burned per unit time or per unit distance. Additionally, it should be understood that, in some examples, a representation of the intensity metric may alternatively be displayed as one of the fitness metrics within the first user interface 315 rather than within the separate second user interface 330 in the three-dimensional environment 350.

In some examples, as shown in FIG. 3M, the electronic device 301 updates the intensity metric in accordance with a determined change in difficulty of the exercise activity. For example, as shown in FIG. 3M, the electronic device 301 visually detects an upward slope of running path 345 in the physical environment 340. In some examples, the upward slope of the running path 345 constitutes an increase in difficulty of the running activity in FIG. 3M. Additionally, the electronic device 301 optionally detects a change in one or more of the fitness metrics associated with the exercise activity that corresponds to an increase in the difficulty of the running activity. For example, as indicated by the fitness metrics in the first user interface 315 in FIG. 3M, the electronic device 301 detects an increase in the heart rate of the user (e.g., to 143 BPM in the representation 305-2) and/or a decrease in the average pace (e.g., to 9 minutes 30 seconds in the representation 305-3) which signify an increase in the difficulty of the running activity due to the upward slope of the running path 345. Other examples of changes in physical properties of the physical environment that may change the difficulty of the exercise activity include changes in elevation, changes in terrain (e.g., from flat concrete or pavement to sand or grass), changes in weather, and/or changes in scenery (e.g., from a city environment to a park environment).

In some examples, when the electronic device 301 determines that the difficulty of the exercise activity is increased as discussed above, the electronic device 301 updates the intensity metric associated with the exercise activity. For example, the electronic device 301 updates the second user interface 330 in the three-dimensional environment 350 such that the representation 331-3 of the third intensity level is visually emphasized, which signifies that the user of the electronic device 301 is running at the third intensity level.

Similarly, the electronic device 301 optionally updates the intensity metric in accordance with a determination that the exercise activity has decreased in difficulty. For example, as shown in FIG. 3N, the electronic device 301 visually detects a downward slope of the running path 345 in the physical environment 340 signifying that the difficulty of the running activity has decreased. Additionally, in some examples, the electronic device 301 detects a change in one or more of the fitness metrics associated with the exercise activity that signifies a decrease in the difficulty of the exercise activity. For example, as indicated by the fitness metrics in the first user interface 315 in FIG. 3N, the electronic device 301 detects a decrease in the heart rate of the user (e.g., to 139 BPM in the representation 305-2) which signifies a decrease in the difficulty of the running activity due to the downward slope of the running path 345.

In some examples, as shown in FIG. 3N, the electronic device 301 updates the second user interface 330 in the three-dimensional environment 350 such that only the representation 331-1 of the first intensity level is visually emphasized, which signifies that the user is running at the first intensity level. In some examples, in accordance with a determination that the decrease in the difficulty of the exercise activity causes the intensity level associated with the exercise activity to fall below a threshold intensity level (e.g., below the second intensity level) and/or below some other indication of the intensity (e.g., fewer than a threshold number of average calories burned per unit time or unit distance and/or less than a threshold difficulty (e.g., 50%, 60%, 65%, 70%, or 75% exercise difficulty), which are optionally based on the user's heart rate), the electronic device 301 prompts the user of the electronic device 301 to increase the difficulty of the exercise activity to therefore increase the intensity. For example, as shown in FIG. 3N, the electronic device 301 displays message element 332 in the three-dimensional environment 350 that prompts the user to adjust (e.g., increase) one or more characteristics of the exercise activity (e.g., prompts the user to increase their running pace while running downhill along the running path 345). As another example, the electronic device 301 optionally displays the message element 332 (or a similar indication) in the three-dimensional environment 350 in accordance with a determination that increasing the difficulty of the exercise activity will enable the user to reach and/or surpass an exercise goal or record, such as an average pace record or goal, a mile time record or goal, calorie burning goal or record, an intensity record or goal, etc. for the running activity.

In some examples, as mentioned previously above, the electronic device 301 determines the intensity metric associated with the exercise activity at least in part based on a terrain, surface material, and/or grade of the physical environment in which the exercise activity is being performed. In FIG. 3O, the user of the electronic device 301 is alternatively performing the running activity in a beach environment that includes sand 347. In some examples, as shown in FIG. 3O, during the exercise activity, the electronic device 301 displays the first user interface 315 that includes representations 305-1 through 305-5 of the fitness metrics associated with the exercise activity in the three-dimensional environment 350 as previously discussed herein. Additionally, as shown in FIG. 3O, the electronic device 301 optionally displays the second user interface 330 corresponding to the intensity metric associated with the exercise activity in the three-dimensional environment 350. In FIG. 3O, the electronic device 301 optionally determines that running on the sand 347 is a high difficulty activity (e.g., in accordance with the factors discussed previously above) and thus visually emphasizes the representation 331-3 of the third intensity level in the second user interface 330.

In some examples, displaying the second user interface 330 corresponding to the intensity metric is in accordance with an intensity competition between the user of the electronic device 301 and a second user, different from the user, of a second electronic device, different from the electronic device 301. For example, as shown in FIG. 3O, the user of the electronic device 301 is competing in a running competition with Megan. In some examples, the electronic device 301 displays a third user interface 335 that includes representations of fitness metrics associated with Megan's exercise activity (e.g., “Megan's Run”) in the three-dimensional environment 350. For example, as shown in FIG. 3O, the third user interface 335 includes representations 309-1 through 309-3 of intensity levels for Megan's run and representations 307-1 through 307-5 of running metrics associated with Megan's run (e.g., similar to the running metrics associated with the user's run discussed previously above). In some examples, the electronic device 301 is displaying the third user interface 335 in the three-dimensional environment 350 based on exercise data provided by the second electronic device that is associated with the second user (e.g., Megan) optionally in real time.

As previously described herein, the electronic device 301 determines the intensity metric based on a relative difficulty of the exercise activity (e.g., determined based on environmental factors and/or user health and/or fitness profiles). As shown in FIG. 3O, the user of the electronic device 301 is running at the third intensity level (e.g., indicated by the visual emphasis of the representations 331-1 through 331-3) and the second user (e.g., Megan) is running at the first intensity level (e.g., indicated by the visual emphasis of the representation 309-1). In FIG. 3O, the user of the electronic device 301 is running on terrain (e.g., the sand 347) that is more difficult than the terrain on which Megan is running. Accordingly, even though Megan is running at a faster average pace (e.g., 7 minutes 50 seconds) than the user of the electronic device 301 (e.g., 9 minutes 35 seconds) and with a faster heart rate (e.g., 150 BPM versus 146 BPM), the user of the electronic device 301 is currently winning the intensity competition over Megan. Therefore, as one advantage, providing an intensity metric that considers environmental factors as well as user health and/or fitness profiles enables a more comprehensive exercise summary to be provided to the user, therefore enhancing user-device interaction and enabling the user to more accurately track and/or meet exercise goals using the electronic device. It should be understood that, in some examples, the intensity metric for the users (e.g., the user of the electronic device 301 and/or Megan) may be accumulated over time to provide an overall intensity score (e.g., an accumulation/total of the instantaneous intensity metrics shown in the first user interface element 309 and the second user interface element 330 in FIG. 3O). For example, the accumulate intensity metric may be presented as a second intensity metric element in the first user interface element 309 and/or the second user interface element 330 in FIG. 3O.

It is understood that the examples shown and described herein are merely exemplary and that additional and/or alternative elements may be provided within the three-dimensional environment relating to the display and tracking of user exercise activities. It should be understood that the appearance, shape, form and size of each of the various user interface elements and objects shown and described herein are exemplary and that alternative appearances, shapes, forms and/or sizes may be provided. For example, the virtual objects representative of user interfaces (e.g., user interfaces 315, 330, and 335) may be provided in an alternative shape than a rectangular shape, such as a circular shape, triangular shape, etc. Additionally or alternatively, in some examples, the various user interface elements described herein may be selected and/or manipulated via user input received via one or more separate input devices in communication with the electronic device(s). For example, where applicable, selection input (e.g., for initiating tracking of the exercise activity) may be received via physical input devices, such as a mouse, trackpad, keyboard, etc. in communication with the electronic device(s).

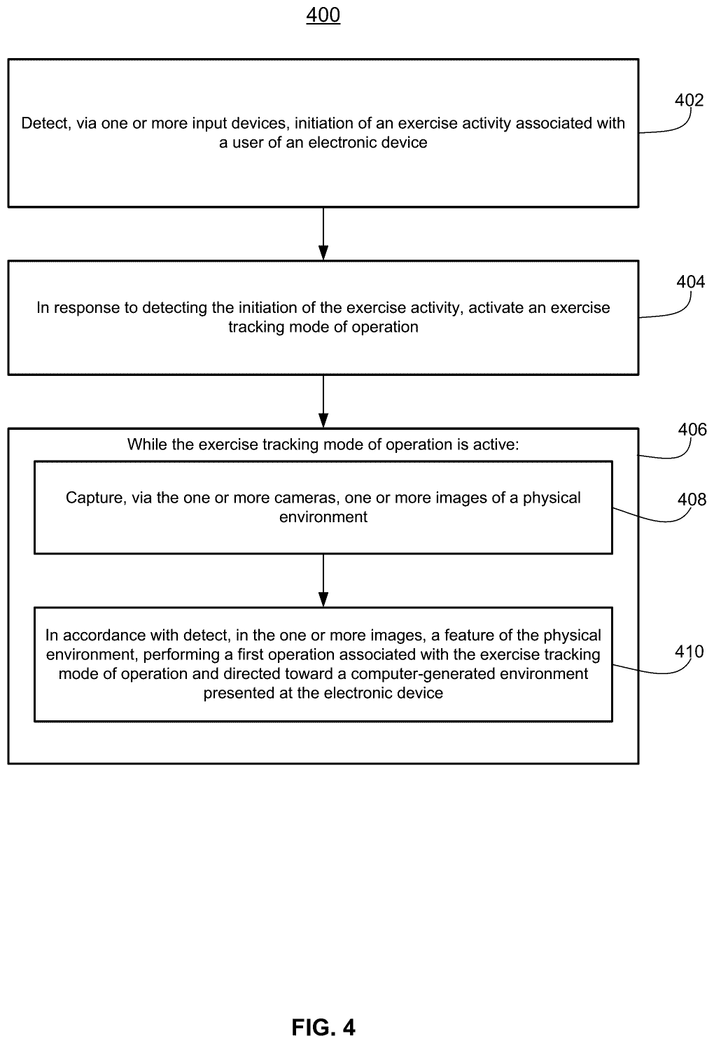

FIG. 4 is a flow diagram illustrating an example process for updating display of a computer-generated environment based on changes in context of an electronic device within a physical environment according to some examples of the disclosure. In some examples, process 400 begins at an electronic device in communication with a display, one or more input devices, and one or more cameras. In some examples, the electronic device is optionally a head-mounted display similar or corresponding to device 201 of FIG. 2. As shown in FIG. 4, in some examples, at 402, the electronic device detects, via the one or more input devices, initiation of an exercise activity associated with a user of the electronic device. For example, as described with reference to FIG. 3B, the electronic device 301 detects movement of the electronic device caused by movement of the user that corresponds to a running or walking activity.

In some examples, at 404, in response to detecting the initiation of the exercise activity, the electronic device activates an exercise tracking mode of operation. For example, as shown in FIG. 3C, the electronic device 301 displays a first user interface 315 in three-dimensional environment 350 that includes one or more representations 305-1 through 305-5 of one or more fitness metrics (e.g., exercise duration, average detected heart rate, exercise distance, etc.) associated with the exercise activity. In some examples, at 406, while the exercise tracking mode of operation is active, the electronic device captures, via the one or more cameras, one or more images of a physical environment. For example, as described with reference to FIG. 3D, the electronic device 301 captures one or more images of physical environment 340 in which the user is performing the exercise activity.

In some examples, at 410, in accordance with detecting, in the one or more images, a feature of the physical environment, the electronic device performs a first operation associated with the exercise tracking mode of operation and directed toward a computer-generated environment presented at the electronic device. For example, as described with reference to FIG. 3E, the electronic device 301 visually detects a first shoe 308-1 and/or a second shoe 308-2 worn on the feet of user 306, which causes the electronic device 301 to display a first user interface element 311 indicating a recorded shoe life of the first shoe 308-1 and/or the second shoe 308-2 and/or a second user interface element 312 indicating a brand of the shoes and/or a shoe type associated with the shoes in the three-dimensional environment 350, as shown in FIG. 3F. As another example, as described with reference to FIG. 3I, the electronic device 301 detects a physical object, such as traffic light 341, that will cause the user to temporarily pause the exercise activity (e.g., because red light 342-1 is illuminated), which causes the electronic device 301 to temporarily cease updating the one or more representations 305-1 through 305-5 of the one or more fitness metrics in the three-dimensional environment 350. In some examples, in accordance with detecting, in the one or more images, no features of the physical environment, the electronic device forgoes performing the first operation associated with the exercise tracking mode of operation and directed toward the computer-generated environment.

It is understood that process 400 is an example and that more, fewer, or different operations can be performed in the same or in a different order. Additionally, the operations in process 400 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method, comprising at an electronic device in communication with a display, one or more input devices, and one or more cameras: detecting, via the one or more input devices, initiation of an exercise activity associated with a user of the electronic device; in response to detecting the initiation of the exercise activity, activating an exercise tracking mode of operation; and while the exercise tracking mode of operation is active, capturing, via the one or more cameras, one or more images of a physical environment, and in accordance with detecting, in the one or more images, a feature of the physical environment, performing a first operation associated with the exercise tracking mode of operation and directed toward a computer-generated environment presented at the electronic device.

Additionally or alternatively, in some examples, the method further comprises, while the exercise tracking mode of operation is active, displaying, via the display, one or more indications associated with one or more fitness metrics corresponding to the exercise activity in the computer-generated environment. Additionally or alternatively, in some examples, the method further comprises: while exercise tracking mode of operation is active and while the one or more indications are displayed in the computer-generated environment, detecting a progression in the exercise activity; and in response to detecting the progression in the exercise activity, updating display, via the display, of the one or more indications based on the progression in the exercise activity. Additionally or alternatively, in some examples, detecting the feature of the physical environment includes detecting a physical object in the physical environment, wherein the physical object includes at least one of a stop sign, a traffic signal, and a vehicle. Additionally or alternatively, in some examples, detecting the feature of the physical environment includes detecting, via the one or more input devices or the one or more cameras, a pause of the exercise activity while the physical object is detected in the physical object. Additionally or alternatively, in some examples, performing the first operation includes forgoing updating display of the one or more indications. Additionally or alternatively, in some examples, the method further comprises: after performing the first operation, detecting, via the one or more input devices, a progression in the exercise activity that includes movement of the electronic device; and in response to detecting the progression in the exercise activity, updating display of the one or more indications based on the progression in the exercise activity.

Additionally or alternatively, in some examples, detecting the feature of the physical environment includes detecting an object that is associated with a portion of the user. Additionally or alternatively, in some examples, the object corresponds to a shoe worn on a foot of the user, and performing the first operation includes displaying an indication of a shoe life associated with the shoe in the computer-generated environment. Additionally or alternatively, in some examples, the object corresponds to a shoe worn on a foot of the user, and performing the first operation includes displaying an indication of a shoe type of the shoe. Additionally or alternatively, in some examples, the method further comprises: while the exercise tracking mode of operation is active, detecting, via the one or more input devices, a conclusion of the exercise activity; and in response to detecting the conclusion of the exercise activity, deactivating the exercise tracking mode of operation. Additionally or alternatively, in some examples, the method further comprises: after deactivating the exercise tracking mode of operation, visually detecting, via the one or more cameras, a shoe worn on a foot of the user; and in response to visually detecting the shoe, displaying, via the display, an indication of information associated with the shoe in the computer-generated environment. Additionally or alternatively, in some examples, the method further comprises, while the exercise tracking mode of operation is active, displaying, via the display, one or more indications associated with an intensity metric corresponding to the exercise activity in the computer-generated environment, wherein the intensity metric measures a relative difficulty of the exercise activity for the user based on the physical environment.

Additionally or alternatively, in some examples, detecting the feature of the physical environment includes detecting terrain in the physical environment that produces a change in the intensity metric. Additionally or alternatively, in some examples, detecting the feature of the physical environment includes detecting a change in elevation or grade of a surface of the physical environment that produces a change in the intensity metric. Additionally or alternatively, in some examples, performing the first operation includes updating the intensity metric corresponding to the exercise activity, including updating display of the one or more indications associated with the intensity metric in the computer-generated environment. Additionally or alternatively, in some examples, updating the intensity metric corresponding to the exercise activity includes, in accordance with a determination that the feature of the physical environment corresponds to a decrease in the intensity metric because the feature of the physical environment will cause the relative difficulty of the exercise activity to decrease below a threshold difficulty for the user, displaying, via the display, a user interface object prompting the user to adjust one or more characteristics of the exercise activity for increasing the relative difficulty of the exercise activity in the computer-generated environment. Additionally or alternatively, in some examples, the exercise activity includes a running activity. Additionally or alternatively, in some examples, the exercise activity includes a cycling activity. Additionally or alternatively, in some examples, the electronic device includes a head-mounted display.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device in communication with a display, one or more input devices, and one or more cameras:
detecting, via the one or more input devices, initiation of an exercise activity associated with a user of the electronic device;
in response to detecting the initiation of the exercise activity, activating an exercise tracking mode of operation; and
while the exercise tracking mode of operation is active:
capturing, via the one or more cameras, one or more images of a physical environment; and
in accordance with detecting, in the one or more images, a feature of the physical environment, performing a first operation associated with the exercise tracking mode of operation and directed toward a three-dimensional environment presented at the electronic device.

2. The method of claim 1, further comprising:
while the exercise tracking mode of operation is active, displaying, via the display, one or more indications associated with one or more fitness metrics corresponding to the exercise activity in the three-dimensional environment;
while exercise tracking mode of operation is active and while the one or more indications are displayed in the three-dimensional environment, detecting a progression in the exercise activity; and
in response to detecting the progression in the exercise activity, updating display, via the display, of the one or more indications based on the progression in the exercise activity.

3. The method of claim 1, wherein detecting the feature of the physical environment includes detecting a physical object in the physical environment that causes a pause of the exercise activity that is detected via the one or more input devices or the one or more cameras, wherein the physical object includes at least one of a stop sign, a traffic signal, and a vehicle.

4. The method of claim 1, wherein:
detecting the feature of the physical environment includes detecting a shoe worn on a foot of the user; and
performing the first operation includes displaying an indication of a shoe life associated with the shoe in the three-dimensional environment.

5. The method of claim 1, further comprising:
while the exercise tracking mode of operation is active, displaying, via the display, one or more indications associated with an intensity metric corresponding to the exercise activity in the three-dimensional environment, wherein the intensity metric measures a relative difficulty of the exercise activity for the user based on the physical environment.

6. The method of claim 5, wherein detecting the feature of the physical environment includes detecting a change in elevation or grade of a surface of the physical environment that produces a change in the intensity metric.

7. The method of claim 5, wherein performing the first operation includes updating the intensity metric corresponding to the exercise activity, including updating display of the one or more indications associated with the intensity metric in the three-dimensional environment.

8. The method of claim 7, wherein updating the intensity metric corresponding to the exercise activity includes:
in accordance with a determination that the feature of the physical environment corresponds to a decrease in the intensity metric because the feature of the physical environment will cause the relative difficulty of the exercise activity to decrease below a threshold difficulty for the user, displaying, via the display, a user interface object prompting the user to adjust one or more characteristics of the exercise activity for increasing the relative difficulty of the exercise activity in the three-dimensional environment.

9. An electronic device comprising:
one or more processors;
memory; and
one or more programs stored in the memory and configured to be executed by the one or more processors, the one or more programs including instructions for performing a method comprising:
detecting, via one or more input devices, initiation of an exercise activity associated with a user of the electronic device;
in response to detecting the initiation of the exercise activity, activating an exercise tracking mode of operation; and
while the exercise tracking mode of operation is active:
capturing, via one or more cameras, one or more images of a physical environment; and
in accordance with detecting, in the one or more images, a feature of the physical environment, performing a first operation associated with the exercise tracking mode of operation and directed toward a three-dimensional environment presented at the electronic device.

10. The electronic device of claim 9, wherein the method further comprises:
while the exercise tracking mode of operation is active, displaying, via the display, one or more indications associated with one or more fitness metrics corresponding to the exercise activity in the three-dimensional environment;
while exercise tracking mode of operation is active and while the one or more indications are displayed in the three-dimensional environment, detecting a progression in the exercise activity; and
in response to detecting the progression in the exercise activity, updating display, via the display, of the one or more indications based on the progression in the exercise activity.

11. The electronic device of claim 9, wherein detecting the feature of the physical environment includes detecting a physical object in the physical environment that causes a pause of the exercise activity that is detected via the one or more input devices or the one or more cameras, wherein the physical object includes at least one of a stop sign, a traffic signal, and a vehicle.

12. The electronic device of claim 9, wherein:
detecting the feature of the physical environment includes detecting a shoe worn on a foot of the user; and
performing the first operation includes displaying an indication of a shoe life associated with the shoe in the three-dimensional environment.

13. The electronic device of claim 9, wherein the method further comprises:
while the exercise tracking mode of operation is active, displaying, via the display, one or more indications associated with an intensity metric corresponding to the exercise activity in the three-dimensional environment, wherein the intensity metric measures a relative difficulty of the exercise activity for the user based on the physical environment.

14. The electronic device of claim 13, wherein detecting the feature of the physical environment includes detecting a change in elevation or grade of a surface of the physical environment that produces a change in the intensity metric.

15. The electronic device of claim 13, wherein performing the first operation includes updating the intensity metric corresponding to the exercise activity, including updating display of the one or more indications associated with the intensity metric in the three-dimensional environment.

16. The method of claim 15, wherein updating the intensity metric corresponding to the exercise activity includes:
in accordance with a determination that the feature of the physical environment corresponds to a decrease in the intensity metric because the feature of the physical environment will cause the relative difficulty of the exercise activity to decrease below a threshold difficulty for the user, displaying, via the display, a user interface object prompting the user to adjust one or more characteristics of the exercise activity for increasing the relative difficulty of the exercise activity in the three-dimensional environment.

17. A non-transitory computer readable storage medium storing one or more programs, the one or more programs comprising instructions, which when executed by one or more processors of an electronic device, cause the electronic device to perform a method comprising:
detecting, via one or more input devices, initiation of an exercise activity associated with a user of the electronic device;
in response to detecting the initiation of the exercise activity, activating an exercise tracking mode of operation; and
while the exercise tracking mode of operation is active:
capturing, via one or more cameras, one or more images of a physical environment; and
in accordance with detecting, in the one or more images, a feature of the physical environment, performing a first operation associated with the exercise tracking mode of operation and directed toward a three-dimensional environment presented at the electronic device.

18. The non-transitory computer readable storage medium of claim 17, wherein the method further comprises:
while the exercise tracking mode of operation is active, displaying, via the display, one or more indications associated with one or more fitness metrics corresponding to the exercise activity in the three-dimensional environment;
while exercise tracking mode of operation is active and while the one or more indications are displayed in the three-dimensional environment, detecting a progression in the exercise activity; and
in response to detecting the progression in the exercise activity, updating display, via the display, of the one or more indications based on the progression in the exercise activity.

19. The non-transitory computer readable storage medium of claim 17, wherein detecting the feature of the physical environment includes detecting a physical object in the physical environment that causes a pause of the exercise activity that is detected via the one or more input devices or the one or more cameras, wherein the physical object includes at least one of a stop sign, a traffic signal, and a vehicle.

20. The non-transitory computer readable storage medium of claim 17, wherein:
detecting the feature of the physical environment includes detecting a shoe worn on a foot of the user; and
performing the first operation includes displaying an indication of a shoe life associated with the shoe in the three-dimensional environment.

21. The non-transitory computer readable storage medium of claim 17, wherein the method further comprises:
while the exercise tracking mode of operation is active, displaying, via the display, one or more indications associated with an intensity metric corresponding to the exercise activity in the three-dimensional environment, wherein the intensity metric measures a relative difficulty of the exercise activity for the user based on the physical environment.

22. The non-transitory computer readable storage medium of claim 21, wherein detecting the feature of the physical environment includes detecting a change in elevation or grade of a surface of the physical environment that produces a change in the intensity metric.

23. The non-transitory computer readable storage medium of claim 21, wherein performing the first operation includes updating the intensity metric corresponding to the exercise activity, including updating display of the one or more indications associated with the intensity metric in the three-dimensional environment.

24. The method of claim 23, wherein updating the intensity metric corresponding to the exercise activity includes:
in accordance with a determination that the feature of the physical environment corresponds to a decrease in the intensity metric because the feature of the physical environment will cause the relative difficulty of the exercise activity to decrease below a threshold difficulty for the user, displaying, via the display, a user interface object prompting the user to adjust one or more characteristics of the exercise activity for increasing the relative difficulty of the exercise activity in the three-dimensional environment.
